(19) United States
(12) Patent Application Publication
(10) Pub. No.: US 2006/0260710 A1
(43) Pub. Date: Nov. 23, 2006

(54) Gas capsules and method of filling them

(76) Inventor: Michael Anthony Barrett, Reading, Berkshire (GB)

Correspondence Address: THE BOC GROUP, INC., 575 MOUNTAIN AVENUE, MURRAY HILL, NJ, 07974-2064, US

(21) Appl. No.: 10/541,799

(22) PCT Filed: Jan. 7, 2004
(86) PCT No.: PCT/GB04/00039

§ 371 Date: Apr. 4, 2006

(30) Foreign Application Priority Data
Jan. 9, 2003 (GB) 0300495.9

(51) Int. Cl. B67C 3/00

(52) U.S. Cl. 141/17

(57) ABSTRACT

A gas capsule comprises a hollow body portion (1) and a cap (2) including a stem (3) providing a filling orifice (3A). Prior to assembly of the body portion (1) and the cap (2) a stopper member (4) is inserted loosely within the capsule. During filling of the capsule with gas, the stopper member (4) is located within the body of the capsule and, prior to release of the gas pressure at the orifice (3A) of the capsule, the stopper member is moved to obstruct the path of gas from the capsule, for example by inverting the capsule so that the stopper member falis under gravity into a position between the body of the capsule (1) and the filling orifice (3A). The gas pressure is then released so that the stopper member (4) is forced into the stem (3) under the pressure of the gas to form a gas tight seal closing the orifice (3A). The orifice (3A) may then be welded to form a permanent closure.

This invention concerns improvements in and relating to gas capsules. More especially, but not exclusively, the invention is concerned with the filling of relatively small gas capsules of the kind intended to be filled at relatively high pressure and then sealed by welding of a filling orifice of the capsule.

Relatively small gas capsules containing a gas such as helium at relatively high pressure and intended for the delivery of small volumes of the gas as a one-shot dose by breakage a seal of the capsule are described for example in EP-A-0757202 and EP-A-0821195. A method of filling and sealing such capsules is described, for example, in EP-A-0947760.

In the filling and sealing of gas capsules of relatively small size with gases, such as helium, at which the vapour pressure at the temperature of filling is higher than the pressure to which the capsule is to be filled, there is particular difficulty in ensuring that the pressure of the gas within the sealed capsule is within desired pressure tolerances. This is because the gas contained within the capsule is not in liquid form, unlike other small gas capsules such as those containing liquid carbon dioxide, and the filling pressure is therefore directly related to the volume of gas within the capsule.

Helium in particular is a gas that is very difficult to confine within a sealed container owing to its ability to permeate through the smallest leakage path, which effectively requires, for a gas capsule of small volume, not only that the container is sealed by welding but that the fusion of the material of the capsule in the weld be sufficient to ensure the integrity of the weld and the exclusion of any potential leakage path due to imperfections such as porosity of the weld.

In EP-A-0947760 as mentioned above, one method for welding such a capsule is described, which involves crimping a neck portion of the capsule whilst the capsule is filled with fluid under pressure and then releasing a free end of the capsule to enable welding thereof to take place in an environment that is free of the gas filling the capsule.

The necessity for maintaining a gas tight crimp at the neck of the capsule during welding thereof is, however, not only inconvenient in manufacture, but is difficult to achieve in a production line involving rapid filling of a multiplicity of capsules.

It is accordingly an object of the invention to provide an improved method of filling and sealing capsules of the kind generally described above.

In accordance with one aspect of the invention, a method of filling a gas capsule of the kind having a hollow body portion and a cap assembled thereto and including a stem providing a filling orifice includes the steps of providing within the capsule prior to assembly of the body portion and the cap portion a stopper member that is loose within the capsule, filling the capsule with gas under pressure, causing the stopper member to adopt a position between the body of the capsule and the filling orifice to obstruct the path of gas from the capsule, and releasing the gas pressure at the orifice of the capsule in order to cause the stopper member to be forced under the pressure of gas within the capsule into gas tight engagement with a portion of the cap member defining a passage to the orifice of the capsule.

The method of the invention has the advantage that, with suitable selection of the configuration and the material of the stopper member and an appropriate configuration of the gas passage that is to receive the stopper member, a gas tight seal can be obtained that is at least sufficient to retain the gas pressure required within the capsule during a subsequent welding step that may be required to ensure an effective seal of the capsule.

The method of EP-A-0947760 may, for example, be applied to the formation of a welded seal of the container, with the exception that the first crimp made in the neck of the container can be effected in a portion of a stem of the container that is on a downstream side of the stopper member with reference to the body of the container, in order that crimping can be effected substantially without the presence of the filling gas at the point of crimping. The possibility of permeation of the filling gas to the environment of the weld during the welding process is thus substantially reduced, thereby improving the quality of the weld.

Further features and advantages of the method in accordance with the invention will become apparent from the following description and the dependent claims.

The invention is illustrated by way of example in the accompanying drawings, in which:

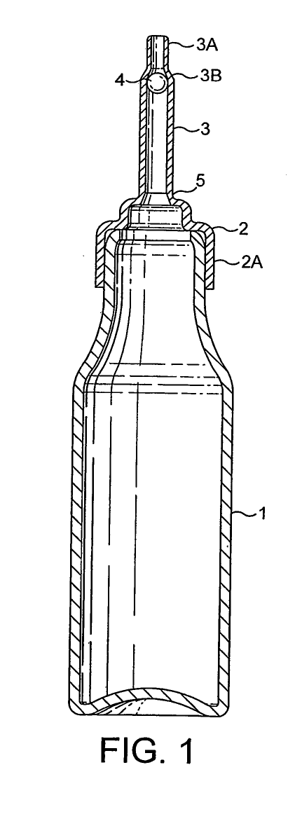

FIG. 1 is a sectional elevation of a gas capsule after filling and sealing by a method in accordance with one embodiment of the invention,

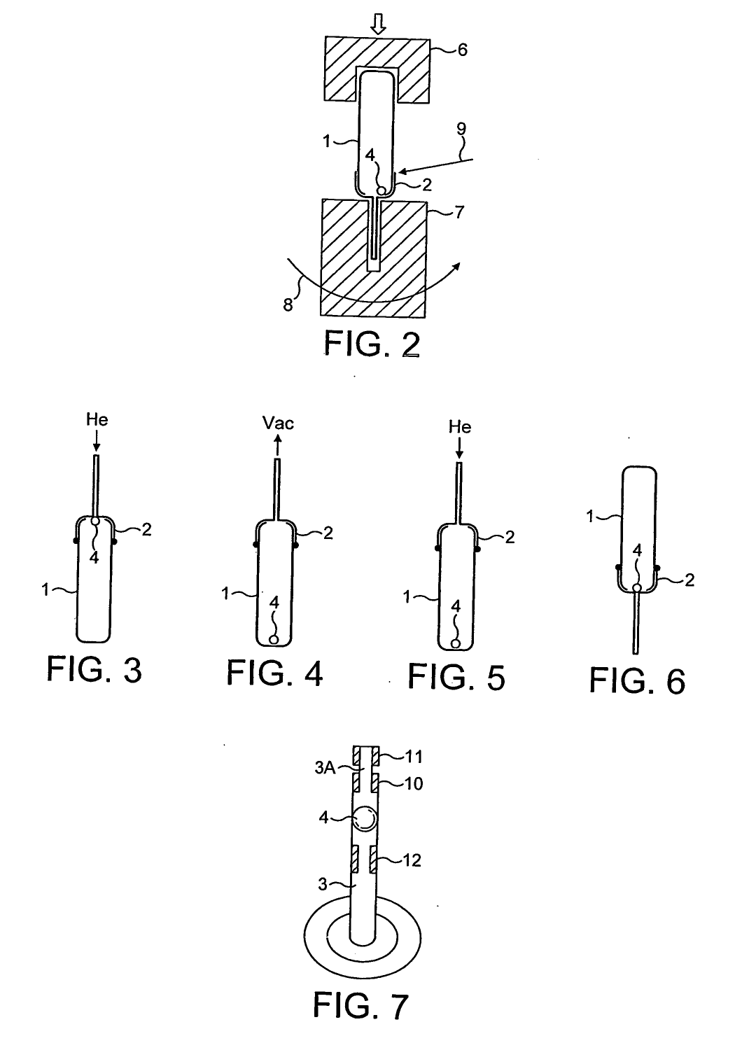

FIGS. 2 to 6 illustrate, in diagrammatic form, steps in a process in accordance with the invention for filling and sealing a capsule of the kind shown in FIG. 1,

FIG. 7 is a diagrammatic view illustrating a method of forming a welded seal at the orifice of the capsule shown in FIG. 1, and

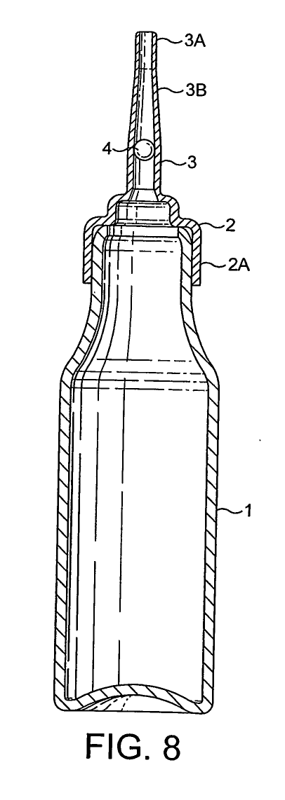

FIG. 8 is a sectional elevation similar to FIG. 1 showing a modified form of capsule.

Referring to FIG. 1, there is illustrated a gas capsule filled and sealed in accordance with one embodiment of the invention. In known manner, the capsule comprises a body portion 1 closed by means of a cap 2, both of which are of generally cylindrical construction. The body of the capsule is closed at an end 1a and is tapered at 1b to form a neck over which engages a rim 2a of the cap 2, the free edge of the rim 2a being welded to the neck of the body 1a by means of a fillet weld, not shown. The cap 2 has an integral stem 3, a forward end 3a of which is of reduced diameter and is intended to be sealed by welding.

As illustrated in FIG. 1, the stem 3 contains a stopper member in the form of an elastomeric ball 4 formed of a material such as silicone rubber that is capable of forming a gas-tight seal by compression against a constricted portion 3b of the stem 3 upstream of the tip 3a of the stem. In the position illustrated in FIG. 1, the ball 4 has been forced into engagement with the stem 3 under pressure of a gas contained within the body 1 of the capsule in a manner that will be described in more detail below. It should be mentioned at this stage, however, that although the ball 4 is illustrated for convenience in FIG. 1 as being of spherical shape, in practice the ball will be resiliently deformed to conform with the internal surface of the stem 3. The ball 4 may be of slightly smaller diameter than the internal diameter of the stem 3. At the junction between the wider portion of the cap 2 and the bore of the stem 3 there is formed a conical surface 5 which assists in leading the ball 4 into the stem 3.

The method of filling of the capsule shown in FIG. 1 will now be described in more detail with the aid of the diagrams of FIGS. 2 to 6.

The ball 4 is initially introduced into the body 1 of the capsule prior to assembly of the body 1 and the cap 2, so that the ball 4 is received loosely within the body 1 and is trapped therein by the cap 2. As shown in FIG. 2, the body 1 and cap 2 are united by laser welding. Whilst held within a fixture comprising upper and lower portions 6 and 7 retaining the body and cap tightly in engagement, the fixture is rotated about the longitudinal axis of the capsule as indicated by the arrow 8 whilst a laser beam 9 is directed at the junction between the body 1 and cap 2 to form the above mentioned fillet weld. During welding, the ball 4 is located within the upper end of the cap 2.

After removal from the fixture 6, 7, the capsule is inverted into the position shown in FIG. 3, and gas pressure is applied to the orifice of the cap 2 via the tip 3a in order to ensure that the ball 4 is displaced away from the cap 2 and rests loosely within the body 1. In a second step shown in FIG. 4, the capsule is evacuated via the stem 3 and is then filled with helium at elevated pressure as indicated in FIG. 5.

The filling pressure of the capsule may be selected according to the intended use of the capsule, and would be typically between 10 and 80 bar.

Whilst the gas pressure is maintained at the desired level, the capsule is inverted, as shown in FIG. 6, in order to cause the ball 4 to drop into the cap 2 so that depending upon the diameter of the ball it either falls into the stem 3 or rests supported by the periphery of the surface 5. The gas pressure applied at the orifice of the tip 3a is then released, causing the ball 4 to be driven by the gas pressure within the capsule so that it becomes arrested to form a seal at the restricted portion 3b of the stem. The capsule is then in the condition as shown in FIG. 1.

In the condition shown in FIG. 1, the capsule is effectively a sealed container containing gas under high pressure. Depending upon the nature of the gas filling, the seal formed by the ball 4 may prove effective for a desired use of the capsule. When the capsule is filled with helium, the seal formed by a silicone rubber ball 4 is insufficient to form a permanent seal owing to the penetrative nature of helium gas, and therefore the tip 3a of the stem 3 must be sealed by welding.

As shown diagrammatically in FIG. 7, the capsule is located in the upright position illustrated in FIG. 1, and the tip 3a of the stem 3 is closed by means of a first crimp formed by a lower pair of crimping jaws 10 that engage the tip 3a just above the constricted portion 3b, and the free end of the tip 3 is then crimped by an upper pair of crimping jaws 11. After release of the jaws 11, the end of the tip 3a is sealed by laser welding in the manner already described above. In addition, in accordance with a preferred feature of the method in accordance with the invention, a third pair of jaws 12 is caused to constrict the stem 3 at a point below the ball 4, to prevent displacement of the ball out of the stem 3 after sealing. It will be appreciated that, once the end of tip 3a is permanently sealed by means of a weld, the permeation of a gas such as helium will enable the gas pressure to become equalised at points above and below the ball 4, and there is thus a possibility that the ball 4 might be released back into the body 1 of the capsule without deformation of the stem 3 in order to trap the ball 4 in position.

It will be appreciated that various alterations may be made to the above described method of the invention without departing from the scope of the appended claims. Thus, although in the method described the ball 4 is caused to move into the position shown in FIG. 6 under the influence of gravity, it is conceivable that movement might be achieved by other means, thus avoiding the need to invert the capsule. As shown in FIG. 8, the method may be applied to a modified form of capsule wherein the constriction 3b of the stem 3 is in the form of a more gradual conical taper rather than a stepped shoulder. The conically tapered constriction 3b may be more suitable for filling the capsule at lower gas pressures, as the mechanical advantage of the portion 3b of the stem in constricting the ball 4 under the application of gas pressure is correspondingly increased. The capsule shown in FIG. 8 may be provided with a welded seal in a similar manner to that described above with reference to FIG. 7.

In practice, the method of the present invention has proved to be successful in the formation of a temporary seal that is sufficient to retain a filling gas such as helium within the capsule during the relatively short period between the filling of the capsule and the subsequent welding of the tip 3a to form a permanent seal.

It will be appreciated that the effectiveness of the gas seal achieved in the described embodiments of the invention is dependent upon suitable selection of appropriate materials for the capsule and the stopper member as well as the relative dimensions of the respective components, the surface finishes thereof and the angle of taper of the constricted portion 3b of the stem 3. Although such parameters may readily be determined by trial and experiment, satisfactory results have been obtained in practice wherein the body portion and cap of the capsule are formed by deep drawing from aluminium, with the internal diameter of the stem 3 at the upstream end of the constriction 3b being between 2.15 and 2.25 mm. The angle of taper of the constricted portion 3b relative to the longitudinal axis of the stem 3 may be in the range of 7°, for the tapering stem shown in FIG. 8, and 60°, for the embodiment of stem shown in FIG. 1. With a stem of such dimensions, the ball 4 may be formed as a sphere of silicone elastomer having a diameter in the region of 2.0 mm to 2.3 mm and having a shore hardness in the region of 45 to 65 IRHD. In order to prevent an elastomeric ball of such dimensions from adhering to the internal wall of an aluminium capsule during the filling process owing to static electricity, the silicone elastomer is preferably rendered electrically conductive either by incorporation therein of a suitable proportion of an electrically conductive material such as carbon black, or by treating the surface thereof with an electrically conductive material such as graphite powder.

Selection of the above parameters has in practice enabled satisfactory sealing of capsules of aluminium, having an internal volume of 3-5 millilitres and filled with helium at pressures from 10 to 80 bar.

1. A method of filling a gas capsule comprising a hollow body portion and a cap assembled thereto and including a stem providing a filling orifice, including the steps of providing within the capsule prior to assembly of the body portion and the cap portion a stopper member that is loose within the capsule, filling the capsule with gas under pressure, causing the stopper member to adopt a position between the body of the capsule and the filling orifice to obstruct the path of gas from the capsule, and releasing the gas pressure at the orifice of the capsule in order to cause the stopper member to be forced under the pressure of gas within the capsule into gas tight engagement with a portion of the cap member defining a passage to the orifice of the capsule.

2. A method according to claim 1, wherein said passage is so formed that it includes within said stem a bore having a constricted portion of reducing diameter, and said stopper member is formed as a ball of resilient material so dimensioned that under the said pressure of gas it is forced into said bore and trapped in fluid tight engagement with the said constricted portion.

3. A method according to claim 2, wherein said bore is provided with a first part of wider diameter adjacent said body portion of said capsule and a second part of narrower diameter adjacent said filling orifice and wherein said constricted portion comprises a shoulder joining said wider and narrower parts and forming a seating for engagement by said ball under said gas pressure.

4. A method according to claim 2, wherein said bore is provided with a first part of wider diameter adjacent said body portion of said capsule and a second part of narrower diameter adjacent said filling orifice and wherein said constricted portion comprises a tapered part of said bore extending between said wider and narrower parts, whereby under the pressure of said gas the said resilient ball is forced along the tapered part and compressed to a point at which it becomes trapped within the bore.

5. A method according to claim 1, wherein said body portion and said cap are formed of aluminium or aluminium alloy.

6. A method according to claim 2 wherein said ball is formed of silicone rubber.

7. A method according to claim 2, wherein after entry of said ball into said bore, the said stem is permanently deformed inwardly to constrict the bore between the body of the capsule and the ball in order to trap the latter within the stem of said cap.

8. A method according to claim 1, wherein after said release of gas pressure at the filling orifice of said stem, the tip of said stem is welded to close the orifice.

9. A method according to claim 8, wherein said welding step includes the steps of crimping the said stem between a first pair of crimping jaws immediately adjacent the orifice in order to flatten and close the latter, crimping the stem at a point spaced from said orifice between a second pair of crimping jaws, releasing the first pair of crimping jaws whilst the stem is located between said second pair of jaws and welding said orifice by directing a laser beam along the line formed by the flattened orifice.

10. A method according to claim 1, wherein prior to said step of filling the capsule with gas under pressure, the capsule is first flushed with gas and then evacuated, said capsule being oriented with said filling orifice in an upward position during flushing and evacuation, whereby said stopper member is caused to rest loosely in the base of the capsule during the evacuation step.

11. A method according to claim 1, wherein the stopper member is caused to adopt said position to obstruct the path of gas, under the influence of gravity, by orienting said capsule with the filling orifice in a downward position.

12. (canceled)
